(19) United States
(12) Patent Application Publication
(10) Pub. No.: US 2025/0309691 A1
(43) Pub. Date: Oct. 2, 2025

(54) CONTACTLESS ELECTRIC POWER TRANSMISSION SYSTEM, MOVABLE BODY, AND CONTACTLESS ELECTRIC POWER TRANSMISSION METHOD

(71) Applicant: HONDA MOTOR CO., LTD., Tokyo (JP)

(72) Inventor: Shuji Kawano, Wako-shi (JP)

(21) Appl. No.: 19/064,804

(22) Filed: Feb. 27, 2025

(30) Foreign Application Priority Data
Mar. 27, 2024 (JP) 2024-051461

(51) Int. Cl. H02J 50/12; B60L 53/122; B60L 53/62

(52) U.S. Cl. CPC H02J 50/12; B60L 53/122; B60L 53/62

(57) ABSTRACT

A contactless electric power transmission system of an embodiment is a contactless electric power transmission system that supplies electric power in a contactless manner from an electric power supply device provided on a movement path of a movable body to an electric power reception device provided on the movable body, wherein the electric power reception device includes: an electric power reception portion that receives electric power by a change of a magnetic field transmitted from the electric power supply device by magnetic field coupling; and a control portion that controls the electric power reception portion, the electric power reception portion includes: a switching circuit that is connected between a resonance capacitor and a coil connected in series and switches between a resonance mode in which electric power is supplied to the resonance capacitor and a short mode in which electric power is not supplied to the resonance capacitor, and the control portion controls the switching circuit so that the mode is switched in accordance with a predetermined condition.

### CROSS-REFERENCE TO RELATED APPLICATION

Priority is claimed on Japanese Patent Application No. 2024-051461, filed on Mar. 27, 2024, the contents of which are incorporated herein by reference.

### BACKGROUND

### Field of the Invention

The present invention relates to a contactless electric power transmission system, a movable body, and a contactless electric power transmission method.

### Background

In recent years, in order to ensure that more people have access to affordable, reliable, sustainable, and advanced energy, research and development relating to charging and electric power supply in a vehicle on which a secondary battery is mounted, which contributes to energy efficiency, has been conducted. In this context, in a contactless electric power transmission system that supplies electric power to a vehicle from the outside of the vehicle, a technique is known in which communication between an electric power transmission side and an electric power reception side is performed by superimposing a communication signal on an electric power supply signal transmitted from the electric power transmission side to the electric power reception side (for example, refer to Japanese Unexamined Patent Application, First Publication No. 2013-247807 and Japanese Patent No. 5348325).

### SUMMARY

In techniques relating to charging and electric power supply in a vehicle on which a secondary battery is mounted, there is a problem that the distance between the electric power transmission side and the electric power reception side is changed when a movable body such as a vehicle is moving, and therefore, it may not be possible to perform appropriate electric power transmission.

The present application aims at providing a contactless electric power transmission system, a movable body, and a contactless electric power transmission method capable of realizing a control of further appropriate electric power transmission even when a movable body is moving. Further, the present application contributes to energy efficiency.

A contactless electric power transmission system according to a first aspect of the present invention is a contactless electric power transmission system that supplies electric power in a contactless manner from an electric power supply device provided on a movement path of a movable body to an electric power reception device provided on the movable body, wherein the electric power reception device includes: an electric power reception portion that receives electric power by a change of a magnetic field transmitted from the electric power supply device by magnetic field coupling; and a control portion that controls the electric power reception portion, the electric power reception portion includes: a switching circuit that is connected between a resonance capacitor and a coil connected in series and switches between a resonance mode in which electric power is supplied to the resonance capacitor and a short mode in which electric power is not supplied to the resonance capacitor, and the control portion controls the switching circuit so that the mode is switched in accordance with a predetermined condition.

A second aspect is the contactless electric power transmission system according to the first aspect described above, wherein the control portion may adjust a ratio of the short mode at a predetermined time in accordance with a target electric power of the electric power reception device.

A third aspect is the contactless electric power transmission system according to the first aspect described above, wherein the control portion may determine a ratio of the short mode based on a rate of a predicted future reception electric power value to a regeneration available output value derived based on an electric power state of an electric power storage portion mounted on the movable body, a temperature of the electric power storage portion, and a supply voltage from the electric power supply device.

A movable body according to a fourth aspect of the present invention is a movable body on which an electric power reception device that receives electric power in a contactless manner from an electric power supply device provided on a movement path is mounted, the movable body including: an electric power reception portion that receives electric power by a change of a magnetic field transmitted from the electric power supply device by magnetic field coupling; and a control portion that controls the electric power reception portion, wherein the electric power reception portion includes: a switching circuit that is connected between a resonance capacitor and a coil connected in series and switches between a resonance mode in which electric power is supplied to the resonance capacitor and a short mode in which electric power is not supplied to the resonance capacitor, and the control portion controls the switching circuit so that the mode is switched in accordance with a predetermined condition.

A contactless electric power transmission method according to a fifth aspect of the present invention is a contactless electric power transmission method that supplies electric power in a contactless manner from an electric power supply device provided on a movement path of a movable body to an electric power reception device provided on the movable body, the contactless electric power transmission method including: by way of the electric power reception device, receiving electric power by a change of a magnetic field transmitted from the electric power supply device by magnetic field coupling; and performing a control of switching a mode in accordance with a predetermined condition on a switching circuit that is connected between a resonance capacitor and a coil connected in series and switches between a resonance mode in which electric power is supplied to the resonance capacitor and a short mode in which electric power is not supplied to the resonance capacitor.

According to the first to fifth aspects, it is possible to realize a control of further appropriate electric power transmission even when a movable body is moving.

### BRIEF DESCRIPTION OF THE DRAWINGS

FIG. 1 is a schematic configuration view of a contactless electric power transmission system according to an embodiment.

FIG. 2 is a view showing an example of the configuration of an electric power supply device of the embodiment.

FIG. 3 is a view showing an example of the configuration of a vehicle of the embodiment.

FIG. 4 is a view showing a transition of an operation mode.

FIG. 5 is a view showing an example of a circuit configuration of an electric power transmission side and an electric power reception side of the embodiment.

FIG. 6 is a view showing an example of a circuit configuration of an electric power transmission portion and an electric power reception portion.

FIG. 7 is a view showing an example of a flow of a current in a switching circuit at the time of a resonance mode and at the time of a short mode.

FIG. 8 is a view showing a determination method of a short mode ratio.

FIG. 9 is a flowchart showing an example of an electric power transmission process in the embodiment.

### DESCRIPTION OF EMBODIMENTS

Hereinafter, a contactless electric power transmission system, a movable body, and a contactless electric power transmission method according to an embodiment of the present invention will be described with reference to the drawings.

### System configuration

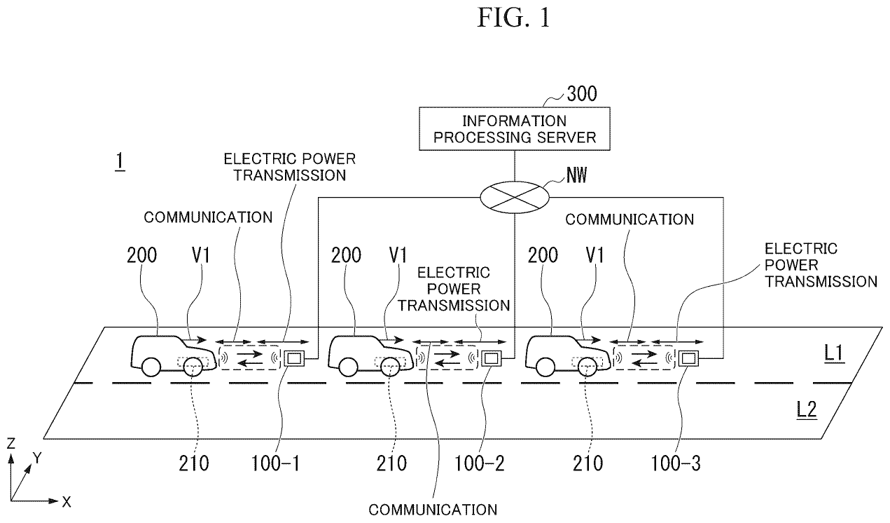

FIG. 1 is a schematic configuration view of a contactless electric power transmission system according to an embodiment. A contactless electric power transmission system 1 according to the embodiment includes, for example, an electric power supply device 100, a vehicle 200 which is an example of a movable body, and an information processing server 300. The electric power supply device 100 and the information processing server 300 communicate with each other, for example, via a network NW. The network NW includes, for example, the Internet, a WAN (Wide Area Network), a LAN (Local Area Network), a cellular network, a public line, a provider device, a wireless base station, and the like. In the contactless electric power transmission system 1, the vehicle 200 may also communicate with the information processing server 300 via the network NW using a communication device mounted on the vehicle 200. Further, in the contactless electric power transmission system 1, the electric power supply device 100 and the vehicle 200 communicate with each other using other communication means described later. Further, in the contactless electric power transmission system 1, the vehicle 200 is, for example, an electric vehicle such as an electric automobile, a hybrid vehicle, a fuel cell vehicle, and the like. The movable body of the embodiment may be an object that is movable on a movement path such as an electric robot other than the vehicle 200. Further, the movable body may carry or may not carry a person on board. Further, the movable body may include a configuration capable of performing not only manual driving by an occupant (driver) but also automatic driving. In the following description, the movable body is a vehicle.

The contactless electric power transmission system 1 supplies electric power from the electric power supply device 100 to the vehicle 200 by contactless electric power transmission between the electric power supply device 100 and the vehicle 200.

In the contactless electric power transmission system 1, the electric power supply device 100 supplies electric power to a plurality of vehicles 200, and the vehicle 200 receives electric power from a plurality of electric power supply devices 100. However, for convenience of explanation, one-to-one contactless electric power supply is mainly described.

The electric power supply device 100 is installed (buried), for example, at a predetermined interval on a road surface of a predetermined electric power supply lane (for example, a lane L1) among lanes L1 and L2 (an example of a movement path) on which the vehicle 200 can travel (for example, electric power supply devices 100-1, 100-2, 100-3 and the like shown in FIG. 1).

The predetermined interval is, for example, an interval at which magnetic field coupling regions of the electric power supply devices 100 do not overlap with each other. Further, the predetermined interval may be set in accordance with a road type (for example, a general road or an expressway) or may be set in accordance with the traffic regulation such as the speed limit of the road. For example, the electric power supply device 100 communicates with the vehicle 200 that approaches within a predetermined distance and supplies electric power in response to an electric power supply request from the vehicle 200. Further, the electric power supply device 100 performs a process related to an electric power protection function (for example, a FSA (Fail Safe Action)) and an electric power control in response to a request.

An electric power reception device 210 is provided on the vehicle 200. The electric power reception device 210 is provided on a bottom portion of the vehicle 200 so as to easily receive electric power and the like from the electric power supply device provided on a road surface; however, the installation position is not limited thereto. The electric power reception device 210 performs a process related to, for example, the vehicle energy management and the electric power protection function (for example, FSA). Further, the vehicle 200 travels using electric power charged in an electric power storage portion such as a mounted battery or supplies electric power to other in-vehicle devices. Further, the vehicle 200 communicates with the electric power supply devices 100-1 to 100-3 while traveling on the electric power supply lane (lane L1), and charges the electric power storage portion mounted on the vehicle 200 using the electric power supplied in response to a request. In the contactless electric power transmission system 1, a communication system required between the electric power supply device 100 and the vehicle 200 is a system that can at least individually identify the vehicle 200 and can communicate with the vehicle 200 in a state where the vehicle 200 is moving at a speed V1 of about 0 to 100 [km/h]. Details of the functional configurations of the electric power supply device 100 and the vehicle 200 will be described later.

The information processing server 300 may be, for example, a server device or a PC (Personal Computer) or may be a cloud server or the like constituted of cloud computing including one or more information processing devices. The information processing server 300 communicates with the electric power supply device 100, the vehicle 200, and the like and performs various processes and the like related to electric The information processing server 300 may be, for example, a billing system power. related to contactless electric power supply, may be an electricity bidding system, or may be a system linked to these systems. The billing system is, for example, a system for individually identifying the vehicle 200 and collecting a fee in accordance with the charged electric power. The electricity bidding system performs, for example, various controls and management to conduct low-cost electricity bidding and the like based on demand forecasts.

Further, the information processing server 300 manages the state of the electric power supply device 100, accumulates the electric power supplied from each of the electric power supply devices 100-1 to 100-3 to the vehicle 200, and performs calculation, management, and the like of the actual electric power transmitted to each vehicle 200.

### Electric Power Supply Device

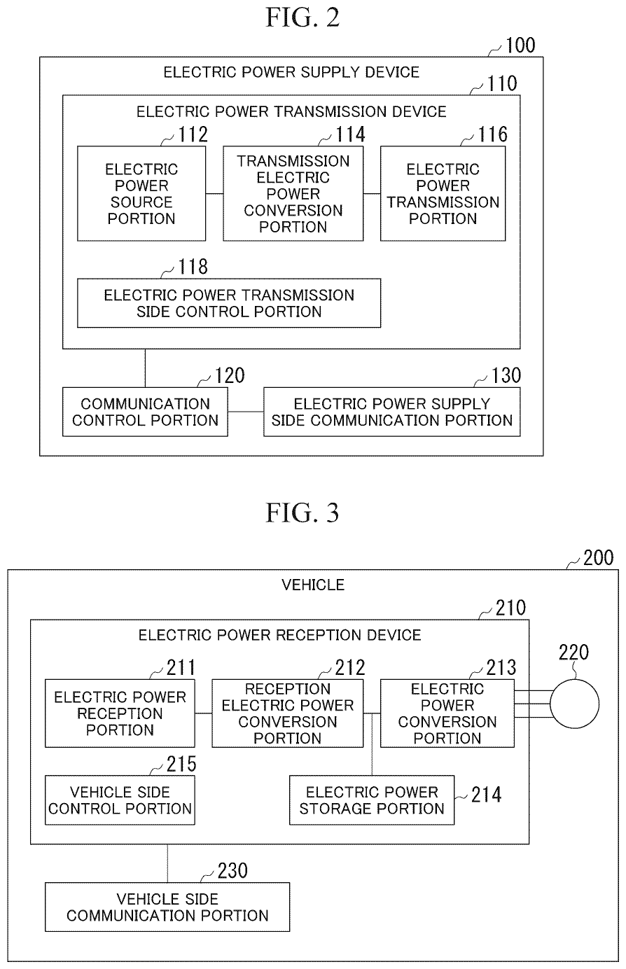

FIG. 2 is a view showing an example of a configuration of the electric power supply device 100 of the embodiment. The electric power supply device 100 includes, for example, an electric power transmission device 110, a communication control portion 120, and an electric power supply side communication portion 130. The electric power transmission device 110 includes, for example, an electric power source portion 112, a transmission electric power conversion portion 114, an electric power transmission portion 116, and an electric power transmission side control portion 118. Some or all of the electric power transmission side control portion 118 and the communication control portion 120 are realized by, for example, a hardware processor such as a CPU (Central Processing Unit) executing a program (software). Some or all of these components may be realized by hardware (a circuit portion including circuitry) such as a LSI (Large Scale Integration), an ASIC (Application Specific Integrated Circuit), a FPGA (Field-Programmable Gate Array), a GPU (Graphics Processing Unit), or a SOC (System on Chip), or may be realized by cooperation of software and hardware. The program may be stored in advance in a storage device (a storage device including a non-transitory storage medium) such as a HDD (Hard Disk Drive) or a flash memory of the electric power supply device 100, or may be stored in a removable storage medium such as a DVD or a CD-ROM and be installed in the HDD or the flash memory of the electric power supply device 100 by attaching the storage medium (non-transitory storage medium) to a drive device.

The electric power source portion 112 of the electric power transmission device 110 is connected to the transmission electric power conversion portion 114. The electric power source portion 112 includes, for example, an AC electric power source such as a commercial electric power source, an AC-DC converter that converts AC electric power into DC electric power, and a capacitor for smoothing of electric power.

The electric power source portion 112 converts, for example, AC electric power supplied from the AC electric power source into DC electric power by the AC-DC converter. Further, the electric power source portion 112 performs a smoothing process of electric power by the capacitor at the time of electric power conversion.

The transmission electric power conversion portion 114 is connected to the electric power transmission portion 116. The transmission electric power conversion portion 114 includes, for example, an inverter that converts DC electric power into AC electric power. The inverter includes, for example, a bridge circuit formed of a plurality of switching elements and rectifying elements that are connected by bridge connection in two phases and a resonance capacitor for resonance adjustment of a coil. Details of a circuit configuration of the transmission electric power conversion portion 114 will be described later.

The electric power transmission portion 116 transmits electric power to the outside (for example, the electric power reception device 210 of the vehicle 200) by the change of a high-frequency magnetic field, for example, using magnetic field coupling by magnetic field resonance. In the magnetic field resonance, for example, when a current flows through a coil on the electric power transmission side, a magnetic field oscillation occurs, and this oscillation is transmitted to a resonance circuit on the electric power reception side which resonates at the same frequency and thereby causes a current to flow. Further, the magnetic field coupling may be achieved by a known coupling method such as electromagnetic induction. In the electromagnetic induction, for example, electric power is transmitted by using an induced magnetic flux generated between the electric power transmission side and the electric power reception side.

The electric power transmission side control portion 118 integrally controls each function of the electric power transmission device 110 or the entire electric power supply device 100. For example, the electric power transmission side control portion 118 performs a control of pairing or the like based on information (for example, a pairing signal and an electric power reception side operation mode) and the like obtained by the electric power supply side communication portion 130 communicating with a vehicle side communication portion 230 of the vehicle 200. The pairing signal includes, for example, an electric power reception device ID which is identification information for identifying the electric power reception device 210 or a vehicle ID which is identification information for identifying the vehicle 200, and parameter information such as required electric power or a battery voltage. For example, the electric power transmission side control portion 118 identifies the electric power reception device 210 and the vehicle 200 based on the electric power reception device ID and the vehicle ID, and establishes (completes) pairing. Further, the electric power transmission side control portion 118 may refer to user information or the like registered in advance based on the electric power reception device ID or the vehicle ID, and establish pairing when the user is capable of receiving electric power (can use an electric power supply service). The electric power transmission side control portion 118 controls electric power transmission so that electric power is supplied to the vehicle 200 with which pairing has been established.

The electric power reception side operation mode is an operation mode of the electric power reception device 210 (described later) mounted on the vehicle 200, and includes, for example, a short mode, a parameter transmission mode, a standby mode, an electric power reception mode, and the like. The short mode is a mode of preventing unexpected electric power reception and is, for example, a mode used in FSA and the like. The parameter transmission mode is a mode of transmitting parameter information. The standby mode is, for example, a mode of waiting for the communication with the electric power supply side.

The electric power reception mode is a mode in which pairing is established and an electric power reception portion 211 and a reception electric power conversion portion 212 wait for electric power reception in an operating state, or in which electric power can be received or is being received based on a predetermined frequency (required frequency for resonance).

Further, the electric power transmission side control portion 118 controls the operation mode (electric power transmission side operation mode) of the electric power transmission device 110 in accordance with the situation. For example, the operation mode includes an off mode, a search mode, a standby mode, an electric power transmission mode, and the like. The off mode in the electric power transmission side operation mode is a mode in which a vehicle that provides service does not exist within the electric power transmission service zone (electric road) and the electric power transmission side is not in operation. The search mode is a mode in which pairing with the vehicle 200 is established, the coupling coefficient is increased, a situation in which electric power transmission efficiency can be ensured is detected, and electric power transmission is suspended. The standby mode is, for example, a mode in which communication with the electric power reception side is waited for. The electric power transmission mode is, for example, a state in which electric power can be transmitted based on a required frequency or a state (electric power transmission state) in which electric power is being transmitted.

The electric power transmission side control portion 118 shifts the operation mode of the electric power transmission device 110 from the off mode to the reception (standby) mode, for example, at the time when pairing with the vehicle 200 is established. Further, the electric power transmission side control portion 118 shifts the electric power transmission device 110 from the reception mode to the search mode, for example, when the electric power transmission side control portion 118 receives information such as a required frequency of electric power transmission from the electric power reception device 210 via the communication control portion 120. Further, the electric power transmission side control portion 118 shifts to the electric power transmission mode when the electric power transmission efficiency can be ensured in the search mode. Further, the electric power transmission side control portion 118 performs electric power transmission to the electric power reception device 210 of the vehicle 200 by controlling the on (conductive) and off (interrupted) switching of each switching element of the transmission electric power conversion portion 114 in accordance with information of a preset drive frequency or a required frequency (resonance frequency) received from the vehicle 200 side in the electric power transmission state of the electric power transmission mode. Further, for example, when electric power transmission to the vehicle 200 side becomes impossible or when communication becomes impossible, the electric power transmission side control portion 118 ends pairing and shifts the electric power transmission device 110 to a sleep mode.

Further, the electric power transmission side control portion 118 may perform a control relating to billing and settlement in accordance with the used electric power amount [kWh] after using the system on the vehicle 200 side. The electric power transmission side control portion 118 performs various controls and the like described above based on various information obtained by the communication between the electric power supply side communication portion 130 and the vehicle side communication portion 230.

The communication control portion 120 controls the operation of the electric power supply side communication portion 130. For example, when a plurality of electric power supply side communication portions 130 are present, the communication control portion 120 controls the operations of all electric power supply side communication portions 130. For example, the communication control portion 120 attempts to acquire predetermined information (for example, a pairing signal or information on electric power transmission (for example, a required frequency, information required for billing and settlement after using the system, and the like)) through communication between the electric power supply side communication portion 130 and the vehicle side communication portion 230 of the surrounding vehicle 200 at a timing such as a predetermined period. The communication control portion 120 outputs the acquired information to the electric power transmission side control portion 118, and transmits information (pairing establishment information and information required for starting electric power transmission) acquired from the electric power transmission side control portion 118 and the like to the vehicle side communication portion 230 via the electric power supply side communication portion 130.

The electric power supply side communication portion 130 includes an antenna for wireless communication and the like and communicates wirelessly with an external device (for example, the information processing server 300, the vehicle 200). Further, for example, the electric power supply side communication portion 130 transmits and receives information on electric power transmission from the electric power transmission device 110 to the vehicle 200. Specifically, the electric power supply side communication portion 130 transmits and receives information for pairing with the vehicle 200 side so that electric power is supplied to a specific vehicle 200 by the control of the electric power transmission side control portion 118 and the communication control portion 120, and transmits and receives information for adjusting the transmitted electric power amount. Further, the electric power supply side communication portion 130 may acquire information from another external device via the network NW.

### Vehicle

FIG. 3 is a view showing an example of a configuration of the vehicle 200 of the embodiment. The vehicle 200 includes, for example, the electric power reception device 210, a rotary electric machine 220, and the vehicle side communication portion 230. Although not shown in FIG. 3, the vehicle 200 includes, for example, various in-vehicle devices (examples of a load and an auxiliary machine) such as various devices (a travel control device and the like) for traveling on a road by manual driving by an occupant or automatic driving, a car navigation device, and an audio device. The electric power reception device 210 includes, for example, the electric power reception portion 211, the reception electric power conversion portion 212, an electric power conversion portion 213, an electric power storage portion 214, and a vehicle side control portion (an example of a control portion) 215. The vehicle side control portion 215 is realized by, for example, a hardware processor such as a CPU executing a program (software). Some or all of these components may be realized by hardware (a circuit portion including circuitry) such as an LSI, an ASIC, a FPGA, or a GPU, or may be realized by cooperation of software and hardware. The program may be stored in advance in a storage device (a storage device including a non-transitory storage medium) such as a HDD or a flash memory of the vehicle 200 or the electric power reception device 210, or may be stored in a removable storage medium such as a DVD or a CD-ROM and be installed in the HDD or the flash memory of the vehicle 200 or the electric power reception device 210 by attaching the storage medium (non-transitory storage medium) to a drive device.

The electric power reception portion 211 of the electric power reception device 210 is connected to the reception electric power conversion portion 212. The electric power reception portion 211 receives electric power by the change of a high-frequency magnetic field transmitted from the electric power transmission portion 116, for example, using magnetic field coupling such as magnetic field resonance or electromagnetic induction.

The reception electric power conversion portion 212 is connected to the electric power conversion portion 213. The reception electric power conversion portion 212 converts, for example, AC electric power into DC electric power. The reception electric power conversion portion 212 includes, for example, a bridge circuit formed of a plurality of switching elements and rectifying elements that are connected by bridge connection in two phases and a capacitor for voltage smoothing. Details of a circuit configuration of the reception electric power conversion portion 212 will be described later.

For example, the electric power reception device 210 which includes the electric power reception portion 211 and the reception electric power conversion portion 212 receives electric power transmitted from the electric power transmission device 110 by controlling the on (conductive) and off (interrupted) switching of each switching element of the reception electric power conversion portion 212 in accordance with information on the frequency of electric power transmission by the electric power transmission device 110 by the control of the vehicle side control portion 215.

The electric power conversion portion 213 is connected to the rotary electric machine 220. The electric power conversion portion 213 includes, for example, an electric power converter that performs conversion between DC electric power and AC electric power. The electric power converter includes, for example, an element module and a capacitor for voltage smoothing. The element module includes, for example, a bridge circuit formed of a plurality of switching elements and rectifying elements that are connected by bridge connection in three phases. The element module controls the operation of the rotary electric machine 220 by transmission and reception of electric power.

For example, the element module converts the DC electric power input from positive and negative DC terminals into three-phase AC electric power and supplies the three-phase AC electric power to the rotary electric machine 220 from a three-phase AC terminal, for example, at the time of power running of the rotary electric machine 220. The element module generates a rotation drive force by sequentially commutating the current to three-phase stator windings of the rotary electric machine 220. Further, for example, at the time of regeneration of the rotary electric machine 220, the element module converts three-phase AC electric power input from the three-phase stator windings into DC electric power by driving the switching element of each phase to be on (conductive) and off (interrupted) in synchronization with the rotation of the rotary electric machine 220. The element module is capable of supplying DC electric power converted from the three-phase AC electric power to the electric power storage portion 214.

The rotary electric machine 220 is, for example, a three-phase AC brushless DC motor provided for traveling and driving of a vehicle. The rotary electric machine 220 includes a rotor having a permanent magnet for a field, and a stator having three-phase stator windings that generate a rotating magnetic field that rotates the rotor. The three-phase stator windings are connected to the three-phase AC terminals of the electric power conversion portion 213. The rotary electric machine 220 generates a rotation drive force by performing a power running operation using the electric power supplied from the electric power conversion portion 213. For example, when the rotary electric machine 220 can be connected to a wheel of the vehicle 200, the rotary electric machine 220 generates a travel drive force by performing a power running operation using the electric power supplied from the electric power conversion portion 213. The rotary electric machine 220 may generate electric power by performing a regeneration operation using rotation power input from the wheel side of the vehicle 200. When the rotary electric machine 220 can be connected to an internal combustion engine of the vehicle 200, the rotary electric machine 220 may generate electric power using the power of the internal combustion engine.

The electric power storage portion 214 includes, for example, a battery (an example of a secondary battery) such as a lithium ion battery, a current sensor that detects a current of the battery, a voltage sensor that detects a voltage of the battery, and a temperature sensor that measures a temperature of the battery. The electric power storage portion 214 is connected to the reception electric power conversion portion 212 and the electric power conversion portion 213 described later. For example, by the control of the vehicle side control portion 215, the electric power storage portion 214 is charged by the electric power from the electric power supply device 100 or the rotary electric machine 220 and supplies the charged electric power to the rotary electric machine 220 and various other in-vehicle devices (a load, an auxiliary machine).

The vehicle side control portion 215 integrally controls, for example, each function of the electric power reception device 210 or the entire vehicle 200. For example, the vehicle side control portion 215 generates a control signal indicating the timing of driving each switching element to be on (conductive) and off (interrupted), and generates a gate signal for actually driving each switching element to ON and OFF based on the control signal. For example, the vehicle side control portion 215 controls the switching of each switching element of the electric power reception device 210 and thereby corrects the power factor or the like of the input voltage and the input current while rectifying the AC electric power received from the electric power transmission device 110 into DC electric power.

Further, the vehicle side control portion 215 generates predetermined information (for example, a pairing signal and information on electric power transmission) for transmitting electric power from the electric power supply device 100 and transmits the generated signal to the outside from the vehicle side communication portion 230. The vehicle side control portion 215 may transmit the pairing signal at a predetermined cycle or may transmit the pairing signal at another predetermined timing. Further, when the vehicle side control portion 215 acquires permission information (pairing completion information) indicating that electric power can be supplied from the electric power supply device 100 side, information required for starting electric power transmission, and the like from the vehicle side communication portion 230, target electric power is acquired by a synchronous rectification operation in which a plurality of switching elements of the electric power reception device 210 are synchronously turned on and off and a short-circuit operation in which a secondary side coil is short-circuited, which will be described later. Further, the vehicle side control portion 215 controls the current of the electric power transmission device 110 and thereby performs independent electric power control such as stopping of electric power transmission on the side of the electric power reception device 210.

The information on electric power transmission is, for example, information on the required electric power and the required frequency of electric power transmission, the target output (electric power consumption) for fail-safe purposes, and various abnormalities, or the like. The required electric power of electric power transmission is a target value of the electric power that the electric power reception device 210 receives from the electric power transmission device 110 and is set, for example, in accordance with the target drive force of the vehicle 200 or the rotary electric machine 220, the electric power consumption of various auxiliary machines connected to the electric power storage portion 214, the electric power state (SOC: State Of Charge) of the electric power storage portion 214, and the like. For example, a remaining capacity, a charging rate, and the like of the electric power storage portion 214 are included in the electric power state. The required frequency of electric power transmission is a frequency required for electric power transmission of the electric power transmission device 110 and is set in accordance with the required electric power. The required frequency is set based on, for example, the minimum ground clearance of the vehicle 200, the mounting layout of the electric power reception device 210 on the vehicle 200, and the like so as to prevent a decrease in the output (electric power) and the efficiency of electric power transmission. The required frequency may be set, for example, in accordance with the state of electric power transmission between the electric power transmission device 110 and the electric power reception device 210. Further, the information on electric power transmission may include information required for billing and settlement after using the system.

Further, the vehicle side control portion 215 controls the operation mode of the electric power reception device 210. As described above, the operation mode includes, for example, the short mode, the parameter transmission mode, the standby mode, and the electric power reception mode. In the electric power reception mode, for example, pairing with the electric power supply device 100 is established, and the electric power reception portion 211 and the reception electric power conversion portion 212 are operated to be in a state where it is possible to receive electric power by magnetic field coupling such as magnetic field resonance or electromagnetic induction.

For example, the vehicle side control portion 215 transmits a pairing signal at a predetermined cycle of about several dozen [μs] to several [ms] or the like, and when receiving a response signal to the pairing signal from the electric power supply device 100, the vehicle side control portion 215 shifts the operation mode of the electric power reception device 210 from a sleep mode to the electric power reception mode and starts the electric power reception control for the electric power transmission from the electric power supply device 100 in an electric power transmission zone. Further, when the electric power reception is completed, the vehicle side control portion 215 shifts the operation mode of the electric power reception device 210 from the electric power reception mode to the standby mode.

The vehicle side communication portion 230 includes an antenna for wireless communication or the like and communicates wirelessly with an external device (for example, the information processing server 300, the electric power supply device 100). For example, the vehicle side communication portion 230 transmits and receives information on electric power transmission from the electric power supply device 100. Specifically, the vehicle side communication portion 230 transmits and receives information for performing the pairing with the side of the electric power supply device 100 so that electric power is supplied from a specific power supply device 100 by the control of the vehicle side control portion 215, and transmits and receives information for adjusting the transmitted electric power amount or the like. Further, the vehicle side communication portion 230 may acquire information from another external device via the network NW.

### Transition of Operation Mode in Contactless Electric Power Supply

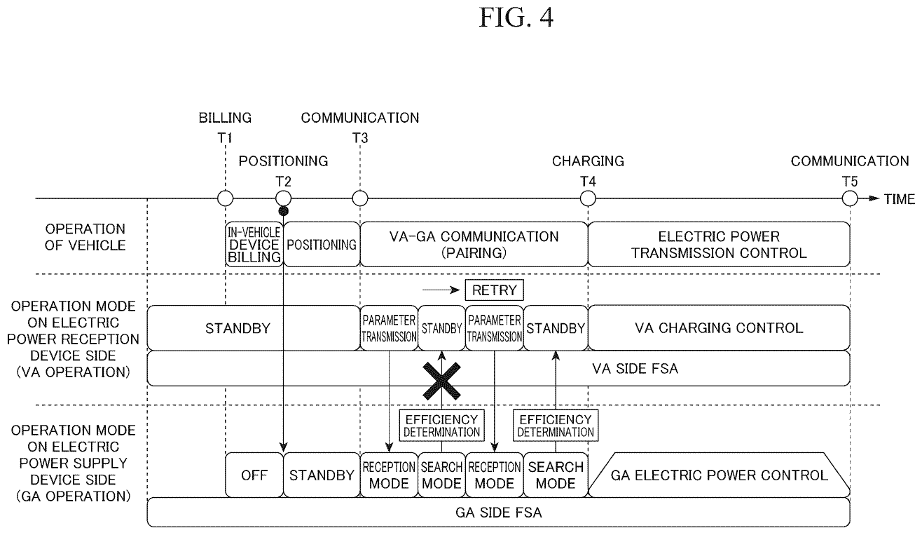

Next, transition of the operation mode of each of the electric power transmission device 110 and the electric power reception device 210 in the contactless electric power supply is described with reference to the drawings. FIG. 4 is a view showing the transition of an operation mode. In the example of FIG. 4, the horizontal axis indicates time, and the vertical axis indicates an operation of the vehicle 200, an operation mode (VA operation) on the side of the electric power reception device 210, and an operation mode (GA operation) of the electric power supply device 100. The operation transition of FIG. 4 shows an example in which contactless electric power transmission is performed between the electric power supply device 100 and the electric power reception device 210 in a state where the vehicle 200 is traveling at a predetermined speed (for example, about 80 [km/h]) as an example. Hereinafter, the transition operation in association with the elapse of time is described. In the example of FIG. 4, in the contactless electric power supply, a FSA (Fail Safe Action) is performed in which abnormality detection is constantly performed at the electric power reception device 210 side and the electric power supply device 100 side, and a control to the safe side is performed when an abnormality is detected (VA side FSA, GA side FSA).

At time T1, the vehicle side control portion 215 of the vehicle 200 communicates with, for example, the information processing server 300 and the like via the vehicle side communication portion 230 and performs a billing process for performing the contactless electric power supply or a pre-process for performing the billing corresponding to the supplied electric power amount (in-vehicle device billing). In a previous step of the time T1, the operation mode on the electric power reception device 210 side is the standby mode. Further, during the billing process, the operation mode on the electric power supply device side is the off mode.

At time T2, after the billing process is completed, positioning of the vehicle 200 is performed so that the electric power reception device 210 passes over the electric power supply device 100 installed on the road surface of the road (for example, an electric power supply lane). In this case, an image showing the position (or the position of the electric power supply lane) of the electric power supply device 100 and the current position of the vehicle 200 is displayed on a display portion (not shown) or the like mounted on the vehicle 200, and the driver performs the positioning by manual driving while watching the image displayed on the display portion. Further, when the vehicle 200 includes a recognition portion (not shown) that recognizes a peripheral situation of the vehicle 200 by using an image captured by an in-vehicle camera or the like and a drive control portion (not shown) that controls at least one of the steering and the speed of the vehicle 200 based on the peripheral situation, positioning may be performed by a control performed by the drive control. For example, when the LKAS (Lane Keeping Assistance System) control (lane keeping control) is being performed by the drive control portion, the vehicle 200 is controlled so as to travel on the middle of the lane, and therefore, by performing the LKAS control and traveling on the electric power supply lane, it is possible to perform the positioning accordingly. During the period from time T2 to time T3, the electric power reception device 210 remains in the short mode, and the electric power supply device 100 shifts from the off mode to the standby mode.

At time T3, when the distance between the electric power reception device 210 and the electric power supply device 100 becomes within a predetermined distance (a distance at which communication is possible) by the traveling of the vehicle 200, the vehicle side control portion 215 of the vehicle 200 starts pairing between the electric power reception device 210 and the electric power supply device 100 by the communication (VA-GA communication). During the period from time T3 to time T4, the vehicle side control portion 215 alternates between the standby mode and the transmission mode in which parameter information (ID, required electric power, battery voltage, and the like) is transmitted until the efficiency of electric power transmission becomes larger than a predetermined value (for example, larger than 0 [%]). On the other hand, the electric power transmission side control portion 118 of the electric power supply device 100 alternates between the reception mode and the search mode. In the search mode, for example, with respect to correspondence relationship information of the electric power (transmission electric power) and the efficiency of electric power transmission in accordance with the horizontal distance (the relative movement amount between the primary side coil and the secondary side coil in the direction parallel to the road surface) in the contactless electric power transmission system 1 of the embodiment set in advance, the efficiency is acquired from the correspondence relationship information for the electric power obtained by the voltage value and the current value. Further, the electric power transmission side control portion 118 determines the efficiency based on the ratio of the voltage and the current, and when the efficiency is equal to or less than a predetermined value, the electric power transmission side control portion outputs that information to the electric power reception device 210 side to perform a retry operation. That is, in the present embodiment, when the transmission efficiency is not suitable for supplying electric power, the communication on the pairing described above can be performed. For example, when the vehicle 200 is traveling at a speed of 80 [km/h], the expected period (expected communication completion time) from time T3 to time T4 is about 22.5 [msec].

At time t4, the efficiency of the electric power transmission becomes larger than the predetermined value, and therefore, the electric power transmission control is performed. For example, the electric power supply device 100 side performs an electric power control (GA electric power control) that transmits electric power corresponding to the required electric power specified by the parameter to the outside. Further, in the electric power reception device 210 side, the electric power transmitted from the electric power supply device 100 is received, and an electric power control (VA charging (electric power reception) control) that stores electric power in the electric power storage portion 214 mounted on the vehicle 200 is performed. That is, the electric power supply device 100 performs communication (pairing communication) with the electric power reception device 210 when the efficiency of the electric power transmission with the electric power reception device 210 is equal to or less than the predetermined value, and the electric power supply device 100 performs the electric power supply control for the electric power reception device 210 when the efficiency becomes larger than the predetermined value. Thereby, pairing communication can be completed in a state where the electric power transmission efficiency is not good, and it is possible to further efficiently perform electric power supply in a state where the electric power transmission efficiency is good.

At time T5, the electric power transmission efficiency is less than the predetermined value, and therefore, the electric power supply operation is ended at this time point. Thereby, it is possible to perform an electric power supply control using efficient electric power transmission. For example, when the vehicle 200 is traveling at 80 [km/h], the expected period (expected electric power transmission time) from time T4 to time T5 is about 18 [msec]. Since the plurality of electric power supply devices 100 are installed at predetermined intervals on the electric power supply lane, the control as shown in FIG. 4 is performed by each electric power supply device 100, and thereby, the vehicle 200 can be charged up to the required electric power. Further, at a time point when the electric power supply is completed, the electric power amount up to the time point is accumulated, and a charging process (billing process) or the like for that amount is performed.

In the above process, the case is described in which the vehicle 200 is traveling at a high speed (for example, 80 [km/h]); however, a similar control may be applied at the time of traveling at a low speed or at the time of stopping. That is, the process of the present embodiment is widely applicable, for example, to the situation in which the speed V1 of the vehicle 200 is in the range of 0 to 100 [km/h]. With respect to the electric power supply in the case of stopping, the electric power control is performed in consideration of a time rating of, for example, 1, 3, or 10 seconds or the like that is set in advance.

### Circuit Configuration of Electric Power Transmission Side and Electric Power Reception Side

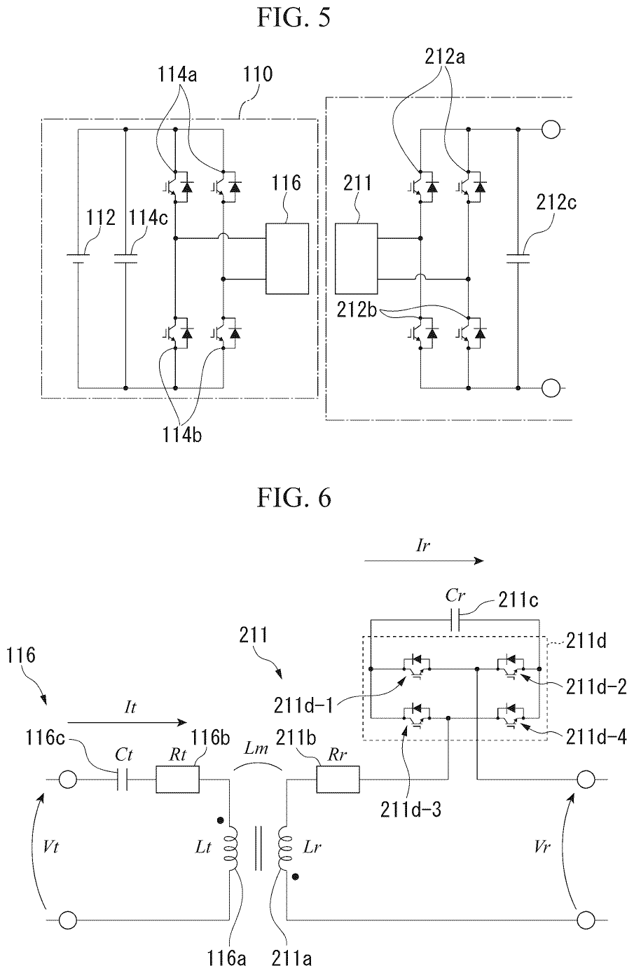

Next, details of a circuit configuration of the electric power transmission side and the electric power reception side are described. FIG. 5 is a view showing an example of a circuit configuration of the electric power transmission side and the electric power reception side of the embodiment. In the example of FIG. 5, mainly, the circuit configuration of the transmission electric power conversion portion 114 in the electric power transmission device 110 and the circuit configuration of the reception electric power conversion portion 212 in the electric power reception device 210 are specifically shown.

The transmission electric power conversion portion 114 includes an inverter that converts DC electric power into AC electric power. The inverter of the transmission electric power conversion portion 114 includes, for example, a bridge circuit formed of a plurality of switching elements and rectifying elements that are connected by bridge connection in two phases and a capacitor for voltage smoothing. Each switching element is, for example, a transistor formed of SiC (Silicon Carbide) or the like. The plurality of switching elements are high-side arm and low-side arm transistors 114a and 114b that form a pair in each phase. The rectifying element is, for example, a reflux diode connected in parallel with each transistor 114a, 114b. A capacitor 114c for voltage smoothing is connected in parallel with the bridge circuit.

For example, the electric power transmission side control portion 118 transmits electric power from the electric power transmission device 110 via the electric power transmission portion 116 by controlling the on (conductive) and off (interrupted) switching of each switching element of the transmission electric power conversion portion 114 in accordance with the required frequency from the electric power reception device 210 side.

The reception electric power conversion portion 212 includes, for example, a bridge circuit formed of a plurality of switching elements and rectifying elements that are connected by bridge connection in two phases and a capacitor for voltage smoothing. Each switching element is, for example, a transistor formed of SiC or the like. The plurality of switching elements are high-side arm and low-side arm transistors 212a and 212b that form a pair in each phase. The rectifying element is, for example, a reflux diode connected in parallel with each transistor 212a, 212b. A capacitor 212c for voltage smoothing is connected in parallel with the bridge circuit. In the embodiment, rectification may be performed by using a diode instead of the transistor 212a, 212b.

For example, the vehicle side control portion 215 receives electric power transmitted from the electric power transmission device 110 via the electric power reception portion 211 by controlling the on (conductive) and off (interrupted) switching of each switching element of the reception electric power conversion portion 212 in accordance with the required frequency.

FIG. 6 is a view showing an example of a circuit configuration of the electric power transmission portion 116 and the electric power reception portion 211. The electric power transmission portion 116 includes, for example, a resonance circuit formed of a primary side coil (Lt) 116a, a primary side resistor (Rt) 116b, and a primary side capacitor (resonance capacitor, Ct) 116c that are connected in series. Further, the electric power transmission portion 116 may include, for example, various sensors such as a current sensor that detects a current (electric power transmission side current) It that flows through the resonance circuit and a voltage sensor that detects a voltage Vt.

The electric power reception portion 211 includes, for example, a resonance circuit formed of a secondary side coil (Lr) 211a, a secondary side resistor (Rr) 211b, and a secondary side capacitor (resonant capacitor, Cr) 211c that are connected in series. The primary side capacitor 116c and the secondary side capacitor 211c are, for example, capacitors for magnetic field resonance. Further, the electric power reception portion 211 may include, for example, various sensors such as a current sensor that detects a current (electric power reception side current) Ir that flows through the resonance circuit and a voltage sensor that detects a voltage Vr.

In the electric power control (electric power supply control) in the contactless electric power transmission of the related art, electric power control on the electric power transmission side that uses the pairing information is common. However, in the contactless electric power supply when the vehicle 200 is traveling, since the electric power reception situation differs for each vehicle 200, the electric power control can be desirably performed on the vehicle 200 side. Therefore, in the embodiment, a circuit (switching circuit) 211d that enables disconnection of the secondary side capacitor (resonance capacitor) 211c in accordance with a predetermined condition is implemented on the resonance circuit on the electric power reception side, and by adjusting a ratio (a short mode ratio described later) of disconnection in accordance with the target electric power, it is possible to achieve a further appropriate electric power reception control on the electric power reception side.

The switching circuit 211d is connected, for example, between the secondary side coil 211a and the secondary side capacitor 211c that are connected in series. The switching circuit 211d shown in FIG. 6 is provided between the secondary side resistor (Rr) 211b and the secondary side capacitor 211c. The switching circuit 211d shown in FIG. 6 includes, for example, a bridge circuit formed of a plurality of switching elements and rectifying elements that are connected by bridge connection in two phases. Each switching element is, for example, a transistor formed of SiC or the like. The rectifying element is, for example, a reflux diode connected in parallel with each of transistors 211d-1 to 211d-4. The switching circuit 211d is connected in parallel with the secondary side capacitor 211c.

The vehicle side control portion 215 receives electric power transmitted from the electric power transmission device 110 by controlling the on (conductive) and off (interrupted) switching of each of the transistors 211d-1 to 211d-4. Further, the vehicle side control portion 215 adjusts an electric power amount at the time of electric power reception in accordance with the target electric power by switching between a resonance mode in which electric power is supplied to the secondary side capacitor 211c to cause resonance and a short mode in which electric power is not supplied to the secondary side capacitor 211c to short-circuit the secondary side coil 211a by the switching control described above. The short mode may also be referred to as a state that does not cause resonance.

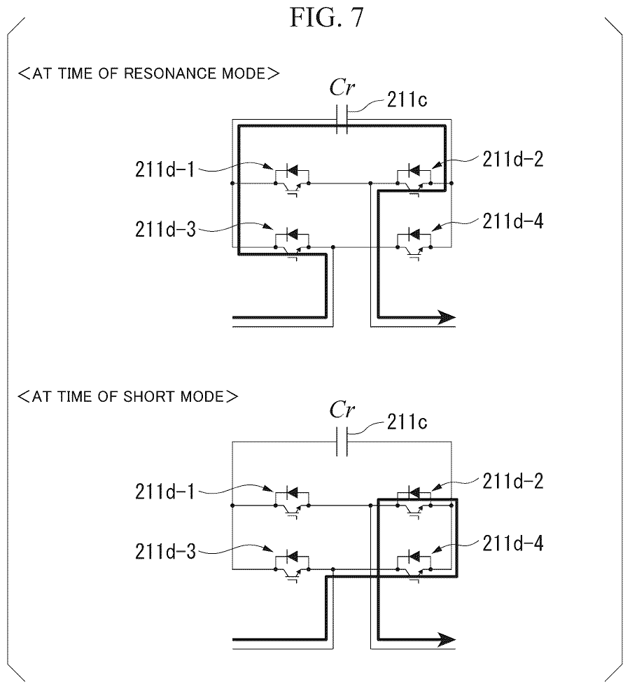

FIG. 7 is a view showing an example of a flow of a current in the switching circuit 211d at the time of the resonance mode and at the time of the short mode. At the time of the resonance mode, the vehicle side control portion 215 performs the switching control of the transistors 211d-1 to 211d-4 such that a current from the secondary side resistor 211b passes through the transistor 211d-3 of the switching circuit 211d, the capacitor 211c, and the transistor 211d-2 and flows to the reception electric power conversion portion 212 side. Further, at the time of the short mode, the switching control of the transistors 211d-1 to 211d-4 is performed such that the current from the secondary side resistor 211b passes through the transistors 211d-4, 211d-2 of the switching circuit 211d and flows to the reception electric power conversion portion 212 side. Thereby, since electric power reception is performed at the time of the resonance mode, and electric power reception is not performed at the time of the short mode, it becomes possible to adjust electric power reception in accordance with the target electric power.

In the embodiment, by providing the switching circuit 211d on the electric power reception device 210 side and adjusting the current that flows to the reception electric power conversion portion 212, it is possible to realize a further appropriate electric power control. Further, in the embodiment, the vehicle side control portion 215 adjusts the short mode ratio (duty ratio) at a predetermined time in accordance with the situation of the vehicle 200, and thereby, it is possible to receive further appropriate target electric power.

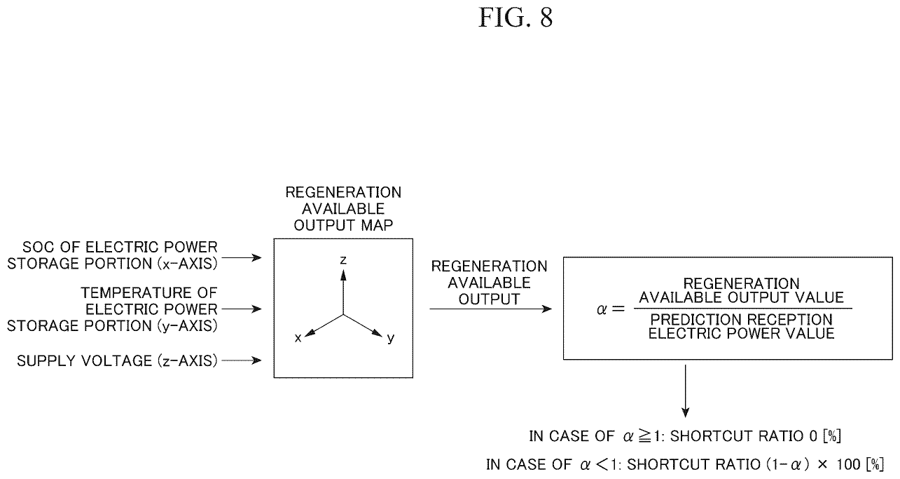

FIG. 8 is a view showing a determination method of the short mode ratio. For example, the vehicle side control portion 215 derives an output value (an example of a target electric power) that can be regenerated by the vehicle 200 based on a SOC (an example of an electric power state) of the electric power storage portion 214 mounted on the vehicle 200, the temperature of the electric power storage portion 214, and a supply voltage (an example of an electric power supply situation) from the electric power supply device 100. In this case, the vehicle side control portion 215 sets a three-dimensional regeneration available output map in which the SOC (State Of Charge) of the electric power storage portion 214, the temperature, and the supply voltage are axes in advance and derives a regeneration available output value based on the set map. In this map, for example, when the SOC of the electric power storage portion 214 is larger, when the temperature is closer to a temperature suitable for regeneration set in advance, and when the supply voltage is larger, the regeneration available output value that is output becomes larger.

Further, the vehicle side control portion 215 may use, in place of the regeneration available output map, a learned model in which the SOC of the electric power storage portion 214, the temperature, and the supply voltage are input, and a regeneration available output value in accordance with the input is output. The learned model is learned, for example, by a function by an AI (Artificial Intelligence) such as machine learning (neural network) or deep learning. The vehicle side control portion 215 may acquire the learned model from the outside via the vehicle side communication portion 230, or the learned model may be stored in a storage portion of the vehicle 200 in advance.

Then, the vehicle side control portion 215 determines the short mode ratio on the basis of the ratio of the derived regeneration available output value and reception electric power value (prediction reception electric power value) at a predetermined time in the future that is predicted in advance based on the situation of the vehicle 200. The prediction reception electric power value may be predicted in the vehicle side control portion 215 on the basis of an average value of a reception electric power amount in the past (a predetermined period until just before the current time) or may be a fixed value. For example, when a value α obtained by dividing the regeneration available output value by the reception electric power value is one or more, the vehicle side control portion 215 does not perform the short mode (short mode ratio 0 [%]), and when α is less than one, the short mode ratio is set to (1−α)×100 [%]. Thereby, the short mode can be further appropriately adjusted in accordance with the state of the vehicle 200, and it is possible to adjust the electric power reception amount in accordance with the target electric power. The determination method of the short mode ratio is not limited to the example described above and may be appropriately adjusted on the basis of, for example, the speed V1 of the vehicle 200, the length of the electric power receivable zone, the performance (electric power transmission performance) of the electric power transmission side and the reception side, or the like.

### Process Flow

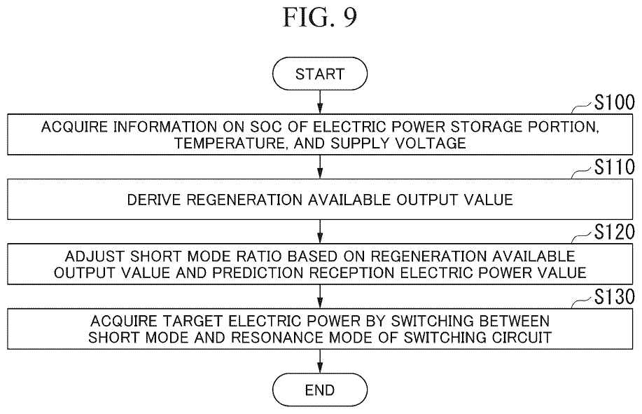

FIG. 9 is a flowchart showing an example of an electric power transmission process in the embodiment. The process of FIG. 9 may be repeatedly performed at a predetermined timing. In the example of FIG. 9, the vehicle side control portion 215 acquires information on the SOC and the temperature of the electric power storage portion 214 and the supply voltage from the electric power supply device 100 (Step S100) and derives a regeneration available output value based on the acquired information (Step S110). Next, the vehicle side control portion 215 adjusts the short mode ratio based on the regeneration available output value and the prediction reception electric power value (Step S120). Next, the vehicle side control portion 215 performs a switching control that switches between the short mode and the resonance mode with respect to the switching circuit 211d based on the short mode ratio and acquires the target electric power (Step S130).

Thereby, the process of the present flowchart ends.

According to the embodiment described above, the contactless electric power transmission system 1 supplies electric power in a contactless manner from the electric power supply device 100 provided on a movement path of the vehicle 200 (an example of a movable body) to the electric power reception device 210 provided on the vehicle 200, wherein the electric power reception device 210 includes: the electric power reception portion 211 that receives electric power by the change of a magnetic field transmitted from the electric power supply device by magnetic field coupling by magnetic field resonance or electromagnetic induction; and the vehicle side control portion 215 (an example of a control portion) that controls the electric power reception portion 211, the electric power reception portion 211 includes: the switching circuit 211d that is connected between the resonance capacitor and the coil connected in series and switches between the resonance mode in which electric power is supplied to the resonance capacitor and the short mode in which electric power is not supplied to the resonance capacitor, and the control portion 215 controls the switching circuit 211d so that the mode is switched in accordance with the predetermined condition. Thereby, it is possible to realize a control of further appropriate electric power transmission even when the vehicle 200 is moving.

Further, according to the embodiment, by implementing a circuit (switching circuit) that disconnects the secondary side capacitor (resonance capacitor, Cr) 211c at the electric power reception device 210 side, it is possible to switch between the resonance state and the non-resonance state. Accordingly, electric power adjustment on the electric power reception device 210 side becomes possible, and electric power adjustment on the electric power supply device 100 side can be unnecessary.

The embodiments of the present invention have been presented as examples and are not intended to limit the scope of the invention. The embodiments can be implemented in a variety of other modes, and various omissions, substitutions, and modifications can be made without departing from the scope of the invention. The embodiments and modifications thereof are included within the scope and gist of the invention and are also included within the scope of the invention described in the appended claims and equivalents thereof.

What is claimed is:

1. A contactless electric power transmission system that supplies electric power in a contactless manner from an electric power supply device provided on a movement path of a movable body to an electric power reception device provided on the movable body,
wherein the electric power reception device comprises:
an electric power reception portion that receives electric power by a change of a magnetic field transmitted from the electric power supply device by magnetic field coupling; and
a control portion that controls the electric power reception portion,
the electric power reception portion comprises: a switching circuit that is connected between a resonance capacitor and a coil connected in series and switches between a resonance mode in which electric power is supplied to the resonance capacitor and a short mode in which electric power is not supplied to the resonance capacitor, and
the control portion controls the switching circuit so that the mode is switched in accordance with a predetermined condition.

2. The contactless electric power transmission system according to claim 1, wherein
the control portion adjusts a ratio of the short mode at a predetermined time in accordance with a target electric power of the electric power reception device.

3. The contactless electric power transmission system according to claim 1,
wherein the control portion determines a ratio of the short mode based on a rate of a predicted future reception electric power value to a regeneration available output value derived based on an electric power state of an electric power storage portion mounted on the movable body, a temperature of the electric power storage portion, and a supply voltage from the electric power supply device.

4. A movable body on which an electric power reception device that receives electric power in a contactless manner from an electric power supply device provided on a movement path is mounted, the movable body comprising:
an electric power reception portion that receives electric power by a change of a magnetic field transmitted from the electric power supply device by magnetic field coupling; and
a control portion that controls the electric power reception portion,
wherein the electric power reception portion comprises: a switching circuit that is connected between a resonance capacitor and a coil connected in series and switches between a resonance mode in which electric power is supplied to the resonance capacitor and a short mode in which electric power is not supplied to the resonance capacitor, and
the control portion controls the switching circuit so that the mode is switched in accordance with a predetermined condition.

5. A contactless electric power transmission method that supplies electric power in a contactless manner from an electric power supply device provided on a movement path of a movable body to an electric power reception device provided on the movable body, the contactless electric power transmission method comprising:
by way of the electric power reception device, receiving electric power by a change of a magnetic field transmitted from the electric power supply device by magnetic field coupling; and
performing a control of switching a mode in accordance with a predetermined condition on a switching circuit that is connected between a resonance capacitor and a coil connected in series and switches between a resonance mode in which electric power is supplied to the resonance capacitor and a short mode in which electric power is not supplied to the resonance capacitor.
